(19) United States
(12) Patent Application Publication
(10) Pub. No.: US 2026/0109227 A1
(43) Pub. Date: Apr. 23, 2026

(54) VEHICLE HAVING INSTRUMENT PANEL MOUNTED DISPLAY

(71) Applicant: Ford Global Technologies, LLC, Dearborn, MI (US)

(72) Inventors: Andrea Viviana Arregui Torres, Atizapán de Zaragoza (MX); Erik James Garland, Commerce Township, MI (US); Luis Enrique Gutierrez Barrera, Cuautitlán Izcalli (MX); Alejandra Matamoros Gutierrez, Mexico City (MX); Roberto Ferro, Atizapán de Zaragoza (MX); Yoon Kim, Northville, MI (US); Thomas Junior Luckett, Saline, MI (US)

(73) Assignee: Ford Global Technologies, LLC, Dearborn, MI (US)

(21) Appl. No.: 18/923,787

(22) Filed: Oct. 23, 2024

(51) Int. Cl. B60K 35/50; B60K 35/22; B60K 35/26; B62D 25/14

(52) U.S. Cl. CPC B60K 35/50; B60K 35/22; B60K 35/26; B62D 25/145; B60K 2360/816

(57) ABSTRACT

A vehicle display system includes an instrument panel substrate configured to extend between first and second front support pillars in a vehicle below a windshield and configured to be supported by a cross-car beam, a sound stage configured to be supported by the cross-car beam, a plurality of brackets configured to be supported by the cross-car beam and an electronic display substantially configured to extend between the first and second front support pillars and be supported by the plurality of brackets. The electronic display is elevated above at least a portion of the instrument panel substrate, wherein the electronic display is vehicle rearward of the sound stage.

### FIELD OF THE DISCLOSURE

The present disclosure generally relates to vehicle display systems, and more particularly relates to an electronic display system installed rearward of the windshield on the instrument panel in a motor vehicle.

### BACKGROUND OF THE DISCLOSURE

Motor vehicles typically include electronic displays for displaying information. For example, electronic displays may be mounted proximate to the vehicle windshield, such as a Head-Up Display (HUD), or a display screen on the instrument panel or dashboard. It may be desirable to provide for a display system configured to be installed on an instrument panel on a motor vehicle that is efficient to service.

### SUMMARY OF THE DISCLOSURE

According to a first aspect of the present disclosure, a vehicle display system includes an instrument panel substrate configured to extend between first and second front support pillars in a vehicle below a windshield and configured to be supported by a cross-car beam, a sound stage configured to be supported by the cross-car beam, a plurality of brackets configured to be supported by the cross-car beam and an electronic display substantially configured to extend between the first and second front support pillars and be supported by the plurality of brackets. The electronic display is elevated above at least a portion of the instrument panel substrate, wherein the electronic display is vehicle rearward of the sound stage.

Embodiments of the first aspect of the present disclosure can include any one or a combination of the following features:
the electronic display has a display curvature between opposite lateral ends;
the electronic display is a panoramic display;
the plurality of brackets comprises a plurality of cross-car beam brackets connected to a plurality of display brackets;
the plurality of brackets comprises first and second cross-car beams brackets and first and second display brackets;
the sound stage is spaced from the electronic display by a gap;
an upper end of the sound stage is angled vehicle forward away from the electronic display;
the sound stage comprises one or more audio speakers;
an instrument panel topper on the instrument panel substrate; and
the electronic display is further connected to the instrument panel substrate.

According to a second aspect of the present disclosure, a vehicle has a body defining a passenger compartment having first and second front support pillars on opposite sides on a front side of the passenger compartment. A windshield is connected to the body and located between the first and second front support pillars. An instrument panel substrate is generally extending between the first and second front support pillars below the windshield. A cross beam extends between the first and second front support pillars. A sound stage is supported on the cross-car beam. A plurality of brackets is supported by the cross beam. An electronic display substantially extends between the first and second support pillars and is supported by the plurality of brackets such that the electronic display is elevated above at least a portion of the instrument panel substrate, wherein the electronic display is vehicle rearward of the sound stage.

Embodiments of the second aspect of the present disclosure can include any one or a combination of the following features:
the electronic display has a display curvature between opposite lateral ends;
the electronic display is a panoramic display;
the plurality of brackets comprises a plurality of cross-car beam brackets connected to a plurality of display brackets;
the plurality of brackets comprises first and second cross-car beams brackets and first and second display brackets;
the sound stage is spaced from the electronic display;
an upper end of the sound stage is angled vehicle forward away from the electronic display;
the sound stage comprises one or more audio speakers;
an instrument panel topper on the instrument panel substrate; and
the electronic display is supported by at least three support brackets.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is an upper rear perspective view of the forward portion of an interior cabin of a motor vehicle having a display system mounted on an instrument panel, according to one embodiment;

FIG. 2 is an upper perspective view of the display system configured to be mounted to a supporting cross beam on the vehicle as shown in FIG. 1;

FIG. 3 is an exploded upper perspective view of the display system and supporting cross car beam shown in FIG. 2;

FIG. 3A is an enlarged perspective view of the cross beam showing the instrument panel substrate in FIG. 3;

FIG. 4 is a partial exploded upper perspective view of the display system having a sound stage configured to be assembled onto the instrument panel substrate;

FIG. 5 is an upper perspective view of the display system further illustrating display mounting brackets that mount the display onto cross beam brackets;

FIG. 5A is an enlarged perspective view of section VA of FIG. 5 illustrating assembly of the electronic display bracket onto the cross beam bracket;

FIG. 6 is an upper perspective view of the display system further illustrating installment of the electronic display;

FIG. 6A is an enlarged perspective view of section VIA further illustrating installment of electronic display onto one of the electronic display brackets;

FIG. 7 is an upper perspective view of the display system illustrating a pair of caps to be assembled over the bracket openings for a fully assembled display system;

FIG. 7A is an enlarged perspective view of section VIIA of FIG. 7 further illustrating installment of the cover cap over the bracket opening;

FIG. 7B is an enlarged perspective view of the cover cap installed over the bracket opening; and

FIG. 8 is an upper rear perspective view of the electronic display.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

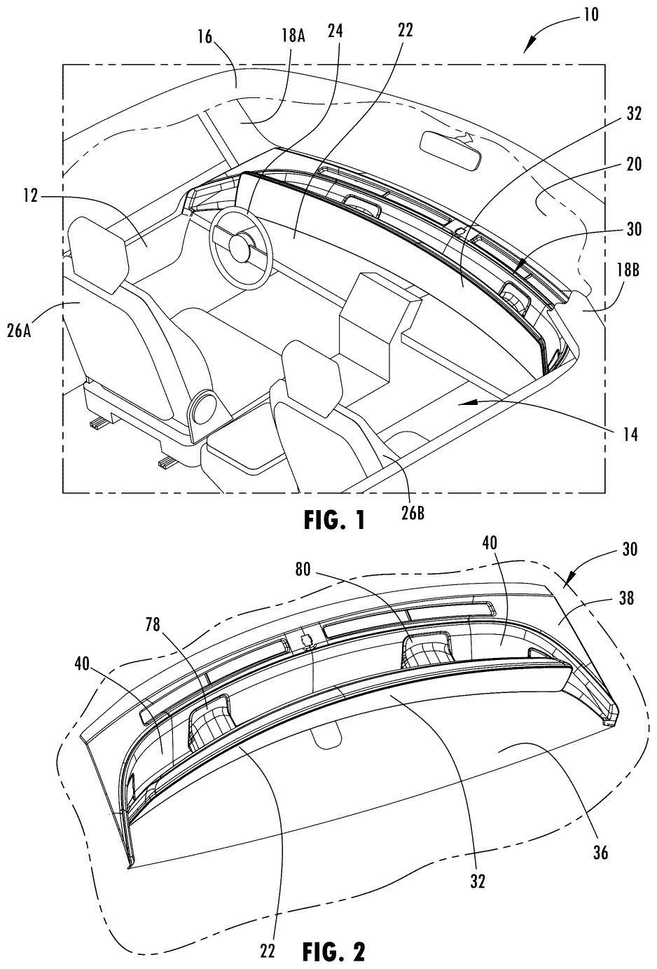

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to a vehicle display system for an instrument panel on a motor vehicle. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIG. 1, a motor vehicle 10, such as a wheeled motor vehicle, is generally illustrated having a vehicle body 12 defining a cabin interior, also referred to as a passenger compartment 14. The passenger compartment 14 generally includes passenger seating, including a front row of seating having a driver seat 26A and a passenger seat 26B. The motor vehicle 10 has a rear row of seating and may have one or more additional rear rows of seating. Located forward of the driver seat 26A is a steering wheel 24. A trim panel in the form of a dashboard, also referred to as an instrument panel 22, extends forward of the first row of seating and forward of the steering wheel 24.

The vehicle body 12 includes a front windshield 20 generally extending across the front end of the passenger compartment 14. The windshield 20 generally extends above and forward of the instrument panel 22. The vehicle body 12 also includes a roof 16 extending along the top above the passenger compartment 14, and first and second side front support pillars 18A and 18B shown located on the front lateral left and right sides of the vehicle body 12. The support pillars 18A and 18B may extend from an underlying frame and connect to the roof 16 at the top end. The windshield 20 thereby extends between the left and right front support pillars 18A and 18B on the left and right sides and extends between the instrument panel 22 and roof 16 on the bottom and top.

The motor vehicle 10 includes an electronic display system 30 shown substantially extending between the first and second front support pillars 18A and 18B and rearward of a lower portion of the windshield 20 inside the passenger compartment 14. The display system 30 is vehicle rearward of the windshield 20 and readily viewable by the driver and passengers looking forward in the passenger compartment 14. The display system 30 is positioned proximate the lower portion of the windshield 20 generally extending within and having an electronic display 32 at least partially extending upwards above the front portion of the instrument panel 22 and extending substantially the full length between the first and second front support pillars 18A and 18B. As such, the electronic display 32 is readily viewable by the driver and passengers looking forward in the motor vehicle 10 by viewing the electronic display 32 proximate the lower portion of the windshield 20.

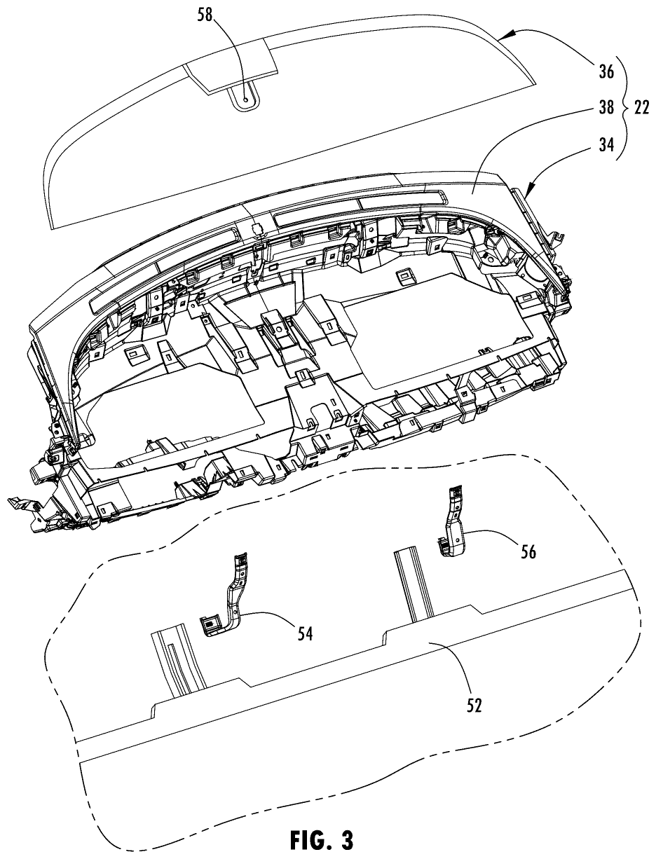

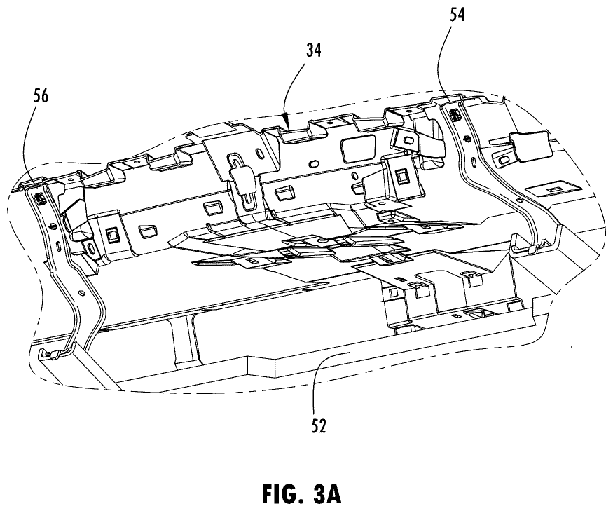

The electronic display system 30 may extend substantially fully between the left side and right side front support pillars 18A and 18B on opposite lateral ends and may be supported by first and second cross-car beam brackets 54 and 56 on a cross-car beam 52. Referring to FIGS. 2 and 3, the display system 30 includes the instrument panel 22 having an instrument panel substrate 34 which is supported on the cross-car beam 52. In one example, the electronic display 32 may extend above the instrument panel 22 and may have a gap on the vehicle forward or on the rear side such that it appears to float in space. In one embodiment, the width of the display system 30 may be less than the distance between the first and second front support pillars 18A and 18B.

The windshield 20 has a sloped contour with a windshield curvature along the width extending between the first and second front support pillars 18A and 18B and along the height extending from the instrument panel 22 to the roof 16. The electronic display 32 may be configured as a panoramic display which has a sloped concave contour with a display curvature along the width and may have a flat or sloped concave contour along the height of the electronic display 32.

The electronic display 32 may be configured as a rigid display formed in the shape of the curved configuration, according to one example. The electronic display 32 may be formed as a flexible display that may be flexed to assume the shape of the curved configuration when mounted onto the motor vehicle 10, according to another example. The electronic display 32 may include any of a number of powered electronic displays configured to display content for viewing. For example, the electronic display 32 may be configured as an organic light emitting diode (OLED) display 30A. The electronic display 32 may be configured as a micro light emitting diode (LED) display, according to another example. The electronic display 32 may be configured as a liquid crystal display (LCD) 30C, according to a further example. Other electronic displays are contemplated.

The display system 30 includes the instrument panel 22 which is shown in FIGS. 3 and 3A having an instrument panel substrate 34 made of a rigid supportive material, such as a polymeric material or a fiberglass material or other suitable material, and an overlaid instrument panel topper 36 which may include a vinyl cover material, for example. The instrument panel substrate 34 is configured to extend between the first and second front support pillars 18A and 18B within the passenger compartment 14 and below the vehicle windshield 20. The instrument panel substrate 34 is configured to be supported by the first and second cross-car beam brackets 54 and 56 which in turn are connected to the cross-car beam 52 at the front of the vehicle cabin as shown in FIG. 3. The cross-car beam 52 may be a metal beam, for example. The instrument panel 22 may further define a defroster grill 38 on the vehicle forward portion proximate to the lower end of the windshield 20. The instrument panel 22 is shown having the instrument panel (IP) substrate 34 connected to the vehicle cross-car beam 52 via first and second cross-car beam brackets 54 and 56. It should be appreciated that the first and second cross-car beam brackets 54 and 56 may include metal brackets which are configured to at least partially support the vehicle display system 30 including the instrument panel 22 and the electronic display 32.

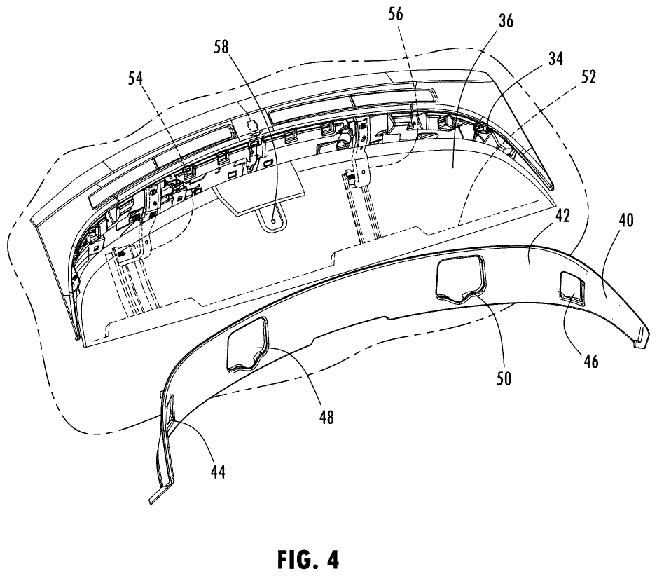

The vehicle display system 30 includes a sound stage 40 which is shown in FIG. 4 installed onto the instrument panel substrate 34 such that the sound stage 40 is also supported by the vehicle cross-car beam 52. The sound stage 40 may be snap fit connected or fastened onto the instrument panel substrate 34. The sound stage 40 includes one or more audio speakers 42 which may be built into the sound stage 40 and may include a sound permeable mesh covering on the front side thereof to emit audio sounds. The sound stage 40 has a curved shape configured to be received within a likewise matching curved shape of the instrument panel substrate 34 and includes a plurality of bracket openings including first and second bracket openings 44 and 46 and third and fourth bracket openings 48 and 50. Each of the bracket openings 44-50 are configured to receive brackets which may in turn be installed to support the electronic display 32.

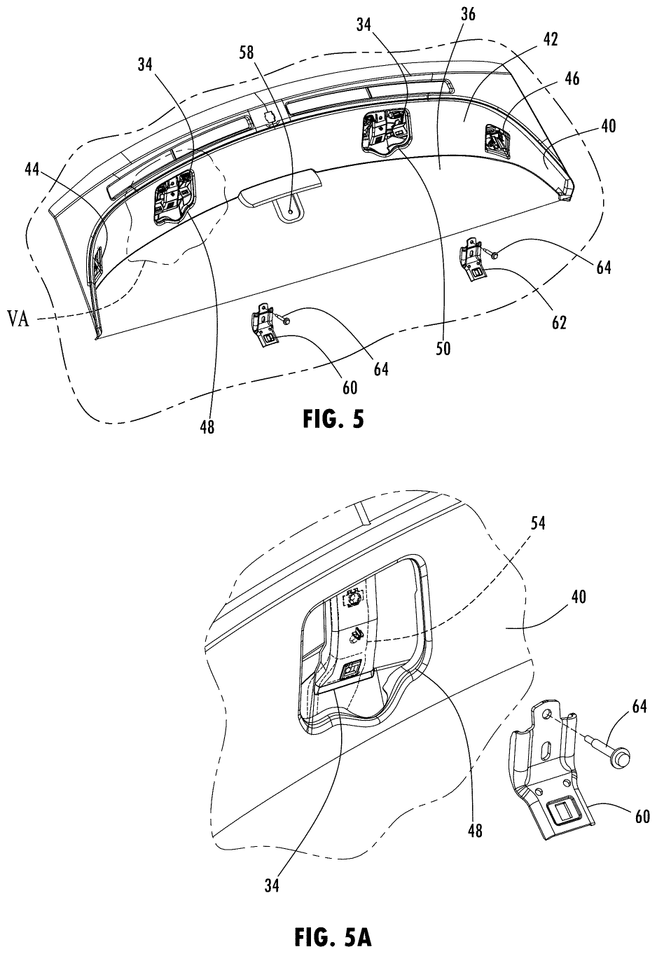

Referring to FIGS. 5 and 5A, the instrument panel substrate 34 is further illustrated having first and second display brackets 60 and 62 extending through the third and fourth bracket openings 48 and 50 in the sound stage 40 such that the first and second display brackets 60 and 62 connect to the corresponding first and second cross beam brackets 54 and 56. The first and second display brackets 60 and 62 are configured to connect to a rear side of the electronic display 32 such that the electronic display 32 is supported on the first and second cross-car beam brackets 54 and 56 and hence the cross-car beam 52. Each of the first and second display brackets 60 and 62 may be fastened onto the first and second cross-car brackets 54 and 56 as shown in FIG. 5A using one or more fasteners 64 such as bolts or screws.

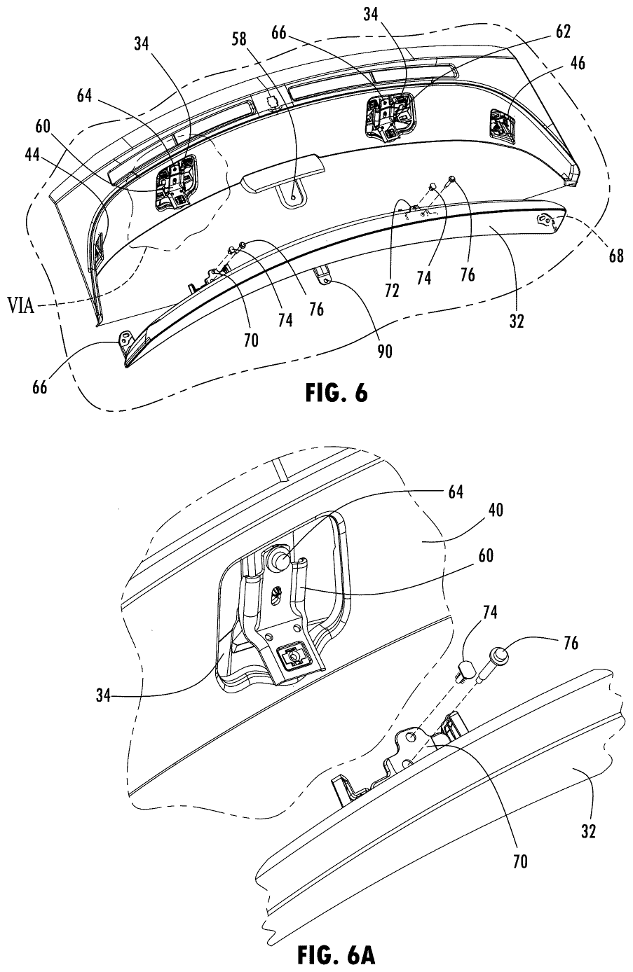

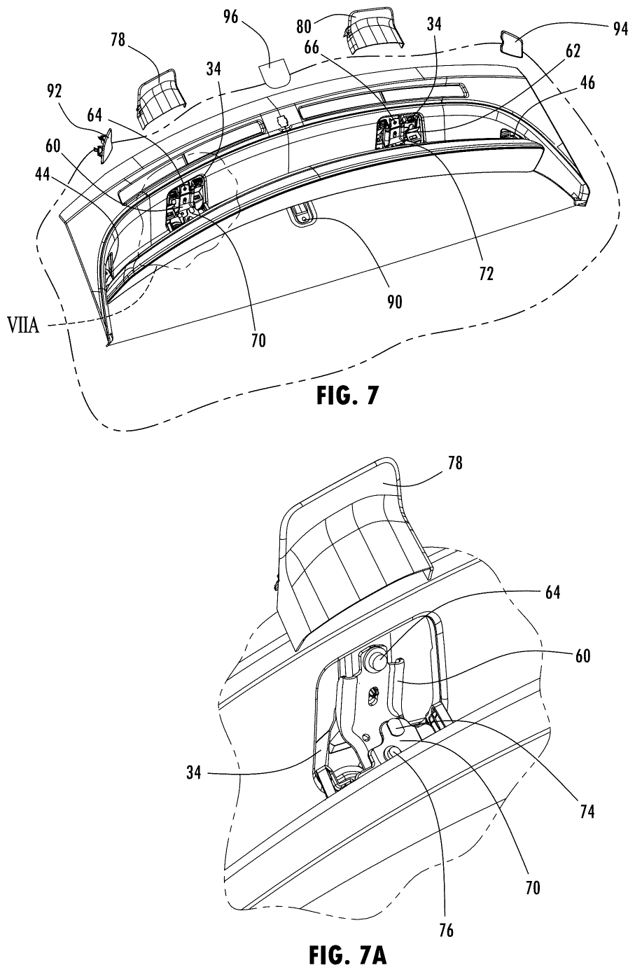

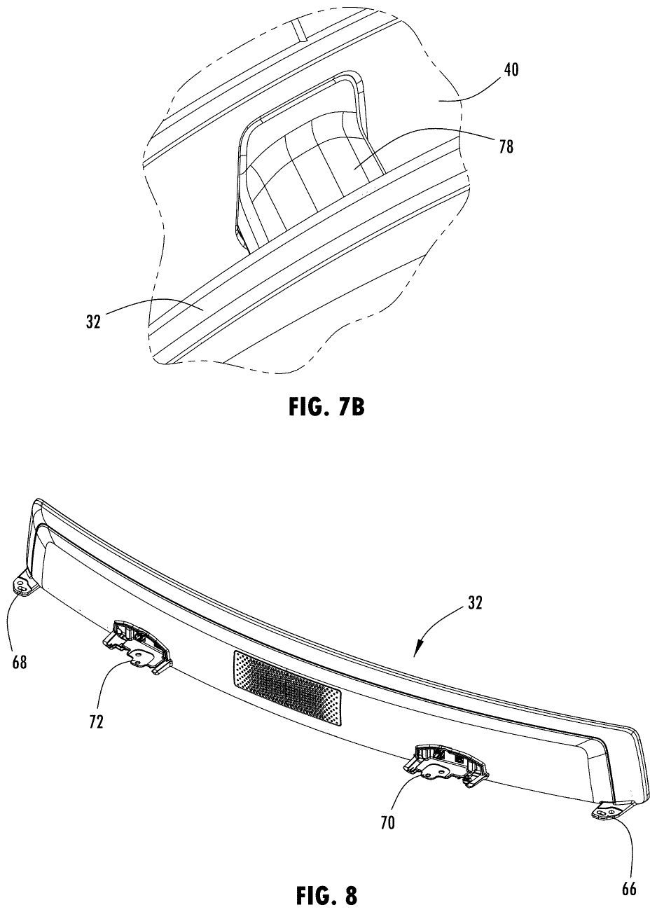

The electronic display 32 is installed onto the vehicle display system 30 vehicle rearward of and spaced by a gap from the sound stage 40 as shown in FIGS. 6-8. The electronic display 32 has first and second connecting brackets 66 and 68 provided on opposite ends configured to extend through openings 44 and 46 to connect to the instrument panel substrate 34. The electronic display 32 further includes bracket connectors 70 and 72 on the rear end configured to align with and connect onto display brackets 60 and 62 which in turn connect to the cross-car beam brackets 54 and 56 and are therefor supported by the cross-car beam 52. Bracket connectors 70 and 72 may be connected to corresponding display brackets 60 and 62 using fasteners 74 and 76 such as bolts or fasteners, according to one example. In addition, the electronic display 32 has a bottom center bracket 80 which is configured to connect such as via a fastener to a display bracket connector 58 that extends through a hole 90 in the instrument panel topper 36 and onto the instrument panel substrate 34. As such, the electronic display 32 is connected to and supported by the cross-car beam 52 using cross-car beam brackets 54 and 56 and display brackets 60 and 62 and bracket connectors 70 and 72. In addition, the electronic display 32 is connected to the instrument panel substrate 34 via brackets 66 and 68 and bottom center bracket 80.

The electronic display 32 is generally forward of or vehicle rearward of the rearward angled sound stage 40 and is spaced therefrom by a gap to enable a user or a mechanic to access the electronic display 32 from within the motor vehicle 10 without requiring removal of the windshield 20 from the motor vehicle 10. This is because a mechanic or user may access the various brackets within the space between the electronic display 32 and the sound stage 40 from within the passenger compartment 14 vehicle-rearward of the windshield 20 and above the instrument panel 22. It should be appreciated that the openings 48 and 50 in the sound stage 40 through which the display brackets 60 and 62 extend may include cover caps 78 and 80, and openings 44 and 46 may include cover caps 92 and 94 which may provide coverings that may be removed during any maintenance or removal of the electronic display 32. A cap 96 further covers hole 90.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A vehicle display system comprising:
an instrument panel substrate configured to extend between first and second front support pillars in a vehicle below a windshield and configured to be supported by a cross-car beam;
a sound stage configured to be supported by the cross-car beam;
a plurality of brackets configured to be supported by the cross-car beam; and
an electronic display substantially configured to extend between the first and second front support pillars and be supported by the plurality of brackets such that the electronic display is elevated above at least a portion of the instrument panel substrate, wherein the electronic display is vehicle rearward of the sound stage.

2. The vehicle display system of claim 1, wherein the electronic display has a display curvature between opposite lateral ends.

3. The vehicle display system of claim 2, wherein the electronic display is a panoramic display.

4. The vehicle display system of claim 1, wherein the plurality of brackets comprises a plurality of cross-car beam brackets connected to a plurality of display brackets.

5. The vehicle display system of claim 4, wherein the plurality of brackets comprises first and second cross-car beams brackets and first and second display brackets.

6. The vehicle display system of claim 1, wherein the sound stage is spaced from the electronic display by a gap.

7. The vehicle display system of claim 6, wherein an upper end of the sound stage is angled vehicle forward away from the electronic display.

8. The vehicle display system of claim 6, wherein the sound stage comprises one or more audio speakers.

9. The vehicle display system of claim 7, further comprising an instrument panel topper on the instrument panel substrate.

10. The vehicle display system of claim 1, wherein the electronic display is further connected to the instrument panel substrate.

11. A vehicle comprising:
a body defining a passenger compartment having first and second front support pillars on opposite sides on a front side of the passenger compartment;
a windshield connected to the body and located between the first and second front support pillars;
an instrument panel substrate generally extending between the first and second front support pillars below the windshield;
a cross beam extending between the first and second front support pillars;
a sound stage supported on the cross-car beam;
a plurality of brackets supported by the cross beam; and
an electronic display substantially extending between the first and second support pillars and supported by the plurality of brackets such that the electronic display is elevated above at least a portion of the instrument panel substrate, wherein the electronic display is vehicle rearward of the sound stage.

12. The vehicle of claim 11, the electronic display has a display curvature between opposite lateral ends.

13. The vehicle of claim 12, wherein the electronic display is a panoramic display.

14. The vehicle of claim 11, wherein the plurality of brackets comprises a plurality of cross-car beam brackets connected to a plurality of display brackets.

15. The vehicle of claim 14, wherein the plurality of brackets comprises first and second cross-car beams brackets and first and second display brackets.

16. The vehicle of claim 11, wherein the sound stage is spaced from the electronic display.

17. The vehicle of claim 16, wherein an upper end of the sound stage is angled vehicle forward away from the electronic display.

18. The vehicle of claim 17, wherein the sound stage comprises one or more audio speakers.

19. The vehicle of claim 16, further comprising an instrument panel topper on the instrument panel substrate.

20. The vehicle of claim 11, wherein the electronic display is supported by at least three support brackets.
